(19) United States
(12) Patent Application Publication
(10) Pub. No.: US 2014/0307178 A1
(43) Pub. Date: Oct. 16, 2014

(54) TOUCH SCREEN SENSING MODULE, MANUFACTURING METHOD THEREOF AND DISPLAY DEVICE

(71) Applicant: SHENZHEN O-FILM TECH CO., LTD, Shenzhen City (CN)

(72) Inventors: GENCHU TANG, Shenzhen City (CN); Shengcai Dong, Shenzhen City (CN); Wei Liu, Shenzhen City (CN); Bin Tang, Shenzhen City (CN)

(73) Assignee: SHENZHEN O-FILM TECH CO., LTD, Shenzhen City (CN)

(21) Appl. No.: 13/968,364

(22) Filed: Aug. 15, 2013

Related U.S. Application Data
(63) Continuation of application No. PCT/CN2013/079318, filed on Jul. 12, 2013.

(30) Foreign Application Priority Data
Apr. 12, 2013 (CN) 201310127475.2

(51) Int. Cl. G06F 1/16

(52) U.S. Cl. CPC G06F 1/1643
USPC 349/12; 216/18

(57) ABSTRACT

A touch screen sensing module, includes a substrate, a first conductive layer and a second conductive layer which are laminated over each other, an insulating adhesive layer is provided between the first conductive layer and the second conductive layer; the first conductive layer includes multiple parallel first conductive strips on the substrate and material of the first conductive strips is transparent semiconductor oxide; the second conductive layer includes multiple parallel second conductive strips provided in the insulating adhesive layer; each of the second conductive strips is a conductive grid formed by intersected fine conductive wires, the first conductive strips and the second conductive strips are insulatedly spaced apart in a thickness direction of the substrate. The touch screen sensing module has only one substrate layer, the thickness is reduced, material is saved and cost is low. A manufacturing method thereof and a display device are further provided.

### CROSS-REFERENCE TO RELATED APPLICATIONS

This application is a continuation of International Application No. PCT/CN2013/079318, filed on Jul. 12, 2013, which claims the priority benefit of China Patent Application No. 201310127475.2, filed on Apr. 12, 2013, both of which are hereby incorporated by reference in their entireties.

### TECHNICAL FIELD

The present invention relates to the field of electronic technology, in particular to a touch screen sensing module, a manufacturing method thereof and a display device with the touch screen sensing module.

### BACKGROUND

A touch screen is a sensing device capable of receiving an input signal such as a touch. The touch screen gives information interaction a new appearance and is a new compelling device for information interaction. In a conventional touch screen, ITO conductive layer remains a very important component of a touch screen sensing module.

The conventional touch screen sensing module mainly adopts a structure in which two pieces of glass are overlaid, ITO conductive patterns are formed on each piece of glass, and ITO patterns on the two pieces of glass spatially overlap with each other to form a structure similar to a capacitor. For the touch screen sensing module adopting this structure, ITO conductive patterns need to be formed on each piece of glass respectively, the production process is complex and lengthy, and therefore the product yield is reduced. In addition, since ITO conductive layers on both two pieces of glass are formed by using etching process, a large amount of ITO material will be wasted, so the cost is relatively high. Furthermore, overlaying two pieces of glass, not only brings difficulty to alignment, but also greatly increases the thickness of the touch screen sensing module.

### SUMMARY

In view of the above, it is necessary to provide a touch screen sensing module, which costs less and has a thinner thickness, and a display device with the touch screen sensing module.

A touch screen sensing module includes a substrate, a first conductive layer and a second conductive layer, where the substrate, the first conductive layer and the second conductive layer are laminated over each other; where an insulating adhesive layer is provided between the first conductive layer and the second conductive layer to insulate the first conductive layer from the second conductive layer; the first conductive layer includes multiple parallel first conductive strips provided on the substrate, and material of the first conductive strips is transparent semiconductor oxide; the second conductive layer includes multiple parallel second conductive strips provided in the insulating adhesive layer, each of the second conductive strips is a conductive grid formed by intersected fine conductive wires; grid-shaped grooves are defined on a surface of the insulating adhesive layer and the second conductive strips are formed by curing a conductive material received in the grid-shaped grooves; the first conductive strips and the second conductive strips are insulatedly spaced apart and overlapped with each other in a thickness direction of the substrate.

In an embodiment, the transparent semiconductor oxide is indium tin oxide, indium zinc oxide, aluminum zinc oxide or gallium zinc oxide.

In an embodiment, the material of the substrate is polyethylene terephthalate, polybutylene terephthalate, polymethyl methacrylate, polycarbonate plastic or glass.

In an embodiment, the material of the fine conductive wires is metal, graphene, carbon nanotube, indium tin oxide, or a conductive polymer.

In an embodiment, the first conductive strips and the second conductive strips overlap perpendicular to each other.

In an embodiment, the insulating adhesive layer includes a first adhesive layer provided on the substrate and a second adhesive layer provided on the first adhesive layer, where the first adhesive layer covers the first conductive layer and the second conductive strips are embedded in the second adhesive layer.

In an embodiment, the touch screen sensing module further includes first electrode leads electrically connected to the first conductive strips and second electrode leads electrically connected to the second conductive strips.

In an embodiment, the first electrode leads are metal plating wires or conductive silver paste wires.

In an embodiment, a recess is provided on a side edge of the insulating adhesive layer, the recess directly faces free ends of the first electrode leads and free ends of the second electrode leads are located at a side of the recess.

In an embodiment, the second electrode leads are divided into two groups and the free ends of the two groups of the second electrode leads are respectively located at two sides of the recess.

In an embodiment, the second electrode leads are solid metal wires, each of the second electrode leads is electrically connected to at least two fine conductive wires of one of the second conductive strips.

In an embodiment, each of the second electrode leads is a conductive grid formed by intersected fine conductive wires, a grid density of the second electrode leads is less than a grid density of the second conductive strips, the second electrode leads are electrically connected to the second conductive strips through solid electrode connecting wires, each of the electrode connecting wires is electrically connected with at least two fine conductive wires of one of the grid-shaped second conductive strips and at least two fine conductive wires of one of the grid-shaped second electrode leads.

A display device includes the touch screen sensing module according to any of the above embodiments.

The touch screen sensing module having the above structure has only one substrate layer, compared to the conventional two layers of glass substrates, the thickness is significantly reduced, the material used is saved and the cost is relatively low. Therefore a display device applying such touch screen sensing module also has lower thickness and lower cost and is conducive to the realization of ultra-thin products.

Furthermore, it is necessary to provide a manufacturing method of touch screen sensing module with relatively simple production process.

A manufacturing method of touch screen sensing module, includes the following steps:

applying a layer of conductive film on a surface of a substrate by vacuum sputtering or evaporation, coating photoresist on the conductive layer, forming multiple parallel first conductive strips from the conductive layer through exposure, development and etching process, where the multiple first conductive strips form a first conductive layer;

coating the substrate with an insulating adhesive layer, where the insulating adhesive layer covers the first conductive layer;

embossing on the insulating adhesive layer by using embossing mold to form multiple strip-shaped grooves overlapping with the first conductive strips, where the strip-shaped grooves include multiple interconnected grid groove units and the strip-shaped grooves are insulatedly spaced apart from the first conductive strips in the thickness direction of the substrate;

filling a conductive material in the strip-shaped grooves to form second conductive strips after being cured so as to obtain a touch screen sensing module, where the multiple second conductive strips form a second conductive layer.

In an embodiment, an embossing surface of the embossing mold is provided with multiple parallel grid-shaped embossments.

In an embodiment, the manufacturing method further includes a step after forming the first conductive layer for forming first electrode leads which are electrically connected with the first conductive strips at an end of the first conductive strips, in particular the step includes:

at the end of the first conductive layer, plating a metal layer, coating photoresist on the metal layer, and forming the multiple first electrode leads through exposure, development and etching process, where the multiple first electrode leads are electrically connected to the multiple first conductive strips respectively; or

printing multiple conductive silver paste strips at an end of the first conductive layer by screen printing to form the first electrode leads, where the multiple conductive silver paste strips are electrically connected to the multiple first conductive strips respectively.

In an embodiment, the coating an insulating adhesive layer includes coating the substrate with a first adhesive layer covering the first conductive layer, coating a surface of the first adhesive layer with a second adhesive layer for being embossed after the first adhesive layer is cured, where the strip-shaped grooves are formed on the second adhesive layer.

In an embodiment, the manufacturing method further includes a step for forming multiple second electrode lead grooves which are connected with the multiple strip-shaped grooves respectively through embossing when forming the strip-shaped grooves through embossing, and then filling a conductive material in the second electrode lead grooves to form second electrode leads electrically connected to the second conductive strips.

In an embodiment, an embossing surface of an embossing mold is provided with multiple parallel grid-shaped embossments for forming the second conductive strips through embossing and provided with multiple grid-shaped embossments or solid embossments respectively connected to the multiple parallel grid-shaped embossments for embossing to form second electrode leads.

In an embodiment, the manufacturing method further includes a step for forming the second electrode leads which are electrically connected to the second conductive strips on a side of the second conductive layer after forming the second conductive layer, in particular the step is:

plating at both ends of the second conductive layer a metal layer, coating photoresist on the metal layer, and forming the multiple second electrode leads through exposure, development and etching process, which are electrically connected to the multiple second conductive strips respectively; or

printing multiple conductive silver paste strips at the both ends of the second conductive layer by screen printing to form the second electrode leads, where the multiple conductive silver paste strips are electrically connected to the multiple second conductive strips respectively.

The above manufacturing method of touch screen sensing module is implemented through coating—photoetching—etching—embossing process, the production process is relatively simple, the obtained first conductive layer and second conductive layer can be aligned according to a preset manner, and therefore the yield of the obtained products is increased.

### BRIEF DESCRIPTION OF DRAWINGS

FIG. 1 is a schematic structural view of a display device according to an embodiment;

FIG. 2 is schematic structural view of the touch screen sensing module illustrated in FIG. 1;

FIG. 3 is an schematic exploded view of the touch screen sensing module illustrated in FIG. 2;

FIG. 4 is a sectional view taken along line I-I of FIG. 1;

FIG. 5 is a sectional view of a touch screen sensing module with an insulating adhesive layer having two adhesive layers;

FIG. 6 is a partial enlarged view of section IV of FIG. 3;

FIG. 7 is a schematic view illustrating the connection between a second electrode lead and a second conductive strip formed by a diamond-shaped conductive grid;

FIG. 8 is a schematic structural view of a second conductive strip formed by an irregular shaped conductive grid;

FIG. 9 is a schematic view illustrating the connection between an electrode connecting wire and a second electrode lead formed by a conductive grid.

### DESCRIPTION OF EMBODIMENTS

In order to facilitate understanding of the present invention, the present invention will be described more comprehensively in the following with reference to relevant drawings. Preferred embodiments of the present invention are provided in the drawings. However, the invention may be implemented in many different forms, and is not limited to the embodiments described herein. Rather, these embodiments are provided so that the disclosure of the invention can be more thoroughly and comprehensively understood.

It should be appreciated that, when an element is described as being “fixed to” another element, the former can be directly fixed to the latter or there can be other element(s) connected between the former and the latter. When an element is described as being “connected” to another element, the former can be directly connected to the latter or there can be other element(s) connected between the former and the latter.

Unless otherwise defined, all technical and scientific terms as used herein have the same meanings as those commonly understood by a person skilled in the art to which the present invention pertains. The terms as used in the specification of the present invention are solely for the purpose of describing the specific embodiments, but not intended to limit the present invention. As used herein, the term “and/or” includes any and all combinations of one or more of the associated listed items.

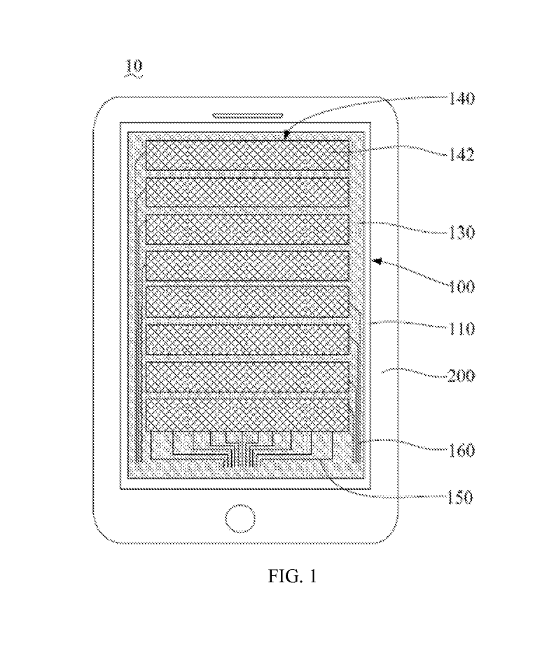

With reference to FIG. 1, in an embodiment, a display device 10 includes a touch screen sensing module 100 and a housing 200. The touch screen sensing module 100 is received in the housing 200.

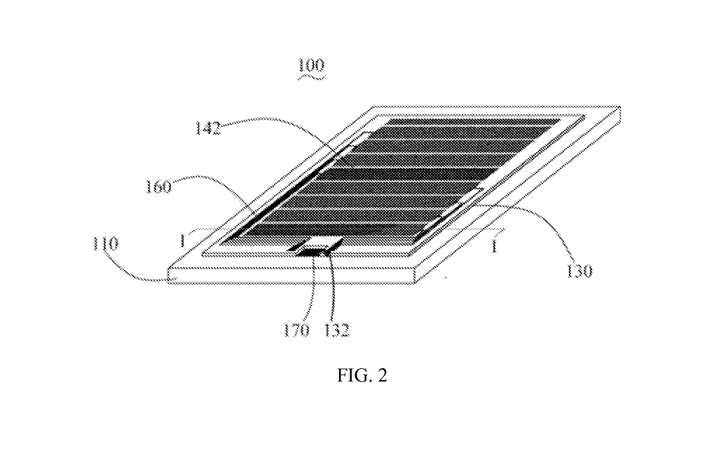

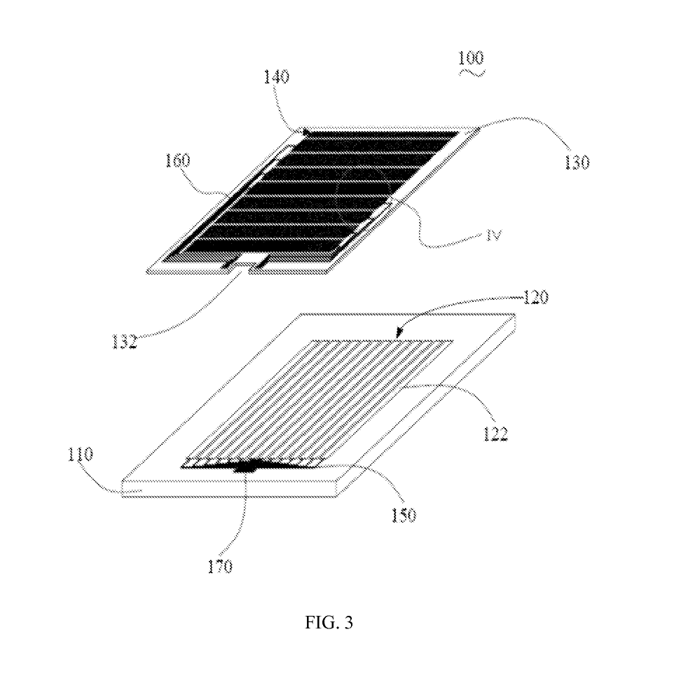

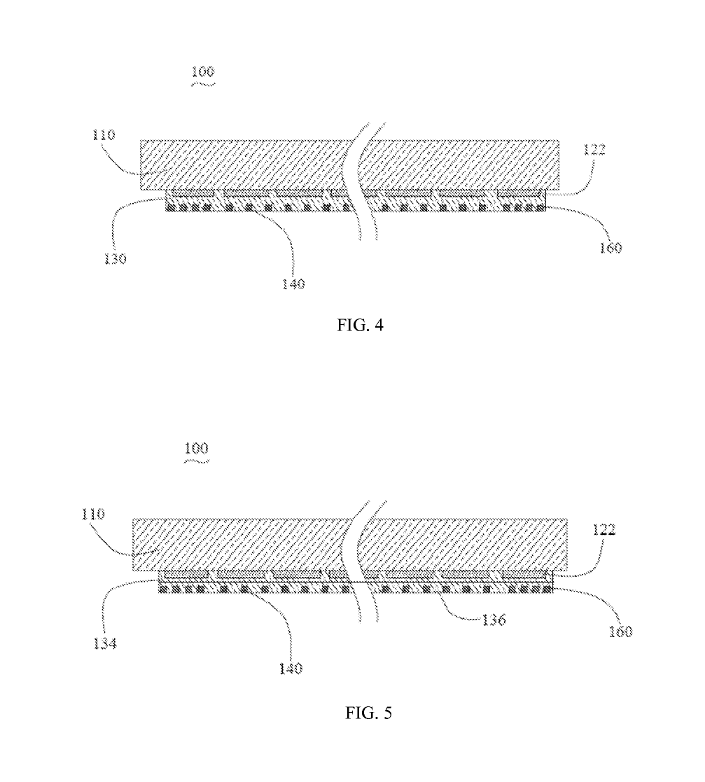

Please also refer to FIG. 2, FIG. 3 and FIG. 4, in this embodiment, the touch screen sensing module 100 includes a substrate 110, a first conductive layer 120, an insulating adhesive layer 130, a second conductive layer 140, first electrode leads 150, second electrode leads 160, and a circuit board 170. The substrate 110, the first conductive layer 120 and the second conductive layer 140 are sequentially laminated, and the insulating adhesive layer 130 is provided on the substrate 110 to insulate the first conductive layer 120 and the second conductive layer 140. The first electrode leads 150 and the first conductive layer 120 are electrically connected. The second electrode leads 160 and the second conductive layer 140 are electrically connected. The circuit board 170 is electrically connected with the first electrode leads 150 and the second electrode leads 160 respectively.

The substrate 110 is made of transparent material and has a rectangular shape. In this embodiment, the material of the substrate 110 is glass. It should be understood that, in other embodiments, the substrate material 110 can also be a transparent substrate made of polyethylene terephthalate (PET), polybutylene terephthalate (PBT), polymethyl methacrylate (PMMA) or poly carbonate (PC) plastic and so on.

The first conductive layer 120 is formed on a surface of the substrate 110. The first conductive layer 120 includes multiple parallel first conductive strips 122. There is a gap between two adjacent first conductive strips 122 and the two adjacent first conductive strips 122 are insulated from each other. In this embodiment, an extending direction of the first conductive strips 122 is parallel to the length direction of the substrate 110. The material of the first conductive strips 122 is indium tin oxide (ITO). It should be understood that, in other embodiments, the extending direction of the first conductive strips 122 may be parallel to the width direction of the substrate 110 or along other feasible directions, and the material of the first conductive strips 122 is not limited to ITO, but can also be other semiconductor oxide materials, especially metal doped n-type metal semiconductor oxide with good transparency and electrical conductivity, such as aluminum zinc oxide (AZO), gallium zinc oxide (GZO) or indium zinc oxide (IZO) etc.

There are multiple first electrode leads 150, each of which is electrically connected to one first conductive strip 122. In this embodiment, the multiple first electrode leads 150 are provided at an end of the conductive strips 122, each of the multiple first electrode leads 150 is electrically connected to one first conductive strip 122 and then converges and is connected to the circuit board 170. Accordingly, the circuit board 170 is provided in the middle portion of one side of the first conductive layer 120 to facilitate the electrical connection with the first electrode leads 150. The first electrode leads 150 may be metal plating wires or conductive silver paste wires.

The insulating adhesive layer 130 is provided on the substrate 110 and covers the first conductive layer 120. The insulating adhesive layer 130 is further embedded in the gaps between adjacent first conductive strips 122, and thus the insulation performance of adjacent first conductive strips 122 is further promoted. A surface of the insulation adhesive layer 130 far away from the first conductive layer 120 defines Grid-shaped grooves (not shown) therein. In this embodiment, the grooves distribute on the surface of the insulating adhesive layer 130 in a strip-shaped form and adjacent grooves are not communicated. The insulating adhesive layer 130 has a recess 132 at the position of the circuit board 170. The recess 132 directly faces free ends of the first electrode leads 150, and free ends of the second electrode leads 160 are located at a lateral edge of the recess 132 to facilitate the mounting of the circuit board 170 on the substrate 110 as well as the electrical connection between the circuit board 170 with the first electrode leads 150 and the second electrode leads 160. In this embodiment, the insulating adhesive layer 130 is integrally formed. It should be understood that in other embodiments, the insulating adhesive layer 130 may be formed by multiple laminated adhesive layers, for example as shown in FIG. 5, the insulating adhesive layer 130 has two adhesive layers, i.e., a first adhesive layer 134 and a second adhesive layer 136. The first adhesive layer 134 is provided on the substrate 110 and covers the first conductive layer 120 and the second adhesive layer 136 is provided on the first adhesive layer 134.

The second conductive layer 140 is embedded in the insulating adhesive layer 130 and includes multiple parallel second conductive strips 142. In this embodiment, an extending direction of the second conductive strips 142 is parallel with the width direction of the substrate 110, i.e., the second conductive strips 142 overlap perpendicular to the first conductive strips 122 in the thickness direction of the substrate 110. Since the first conductive strips 122 and the second conductive strips 142 are insulatedly spaced apart from the insulating adhesive layer 130, a structure similar to capacitance is formed between the first conductive layer 120 formed by the first conductive strips 122 and the second conductive layer 140 formed by the second conductive strips 142. It should be understood that, in other embodiments, the second conductive strips 142 and the first conductive strips 122 may overlap with each other at a non-right angle, but not limited to perpendicularly overlapping, as long as spatial positioning can be achieved by the first conductive layer 120 and the second conductive layer 140 during the use via a touch.

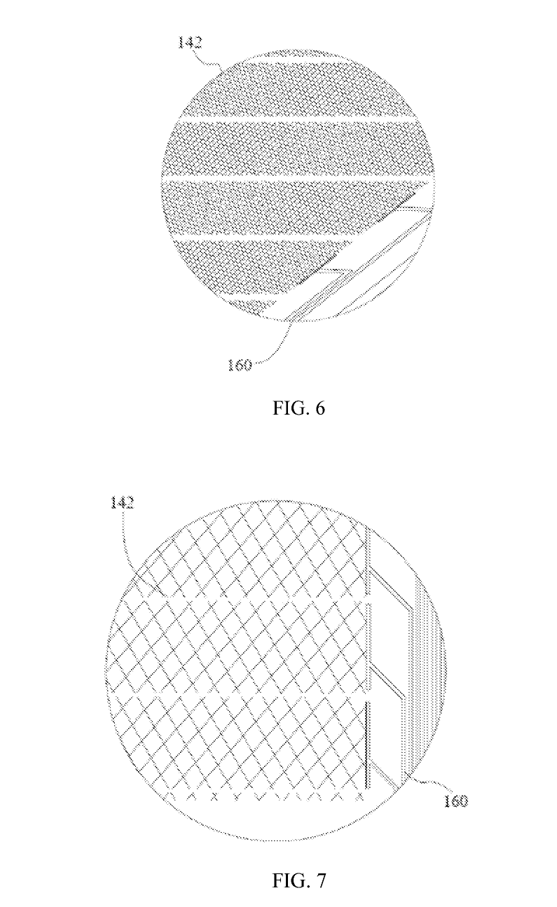

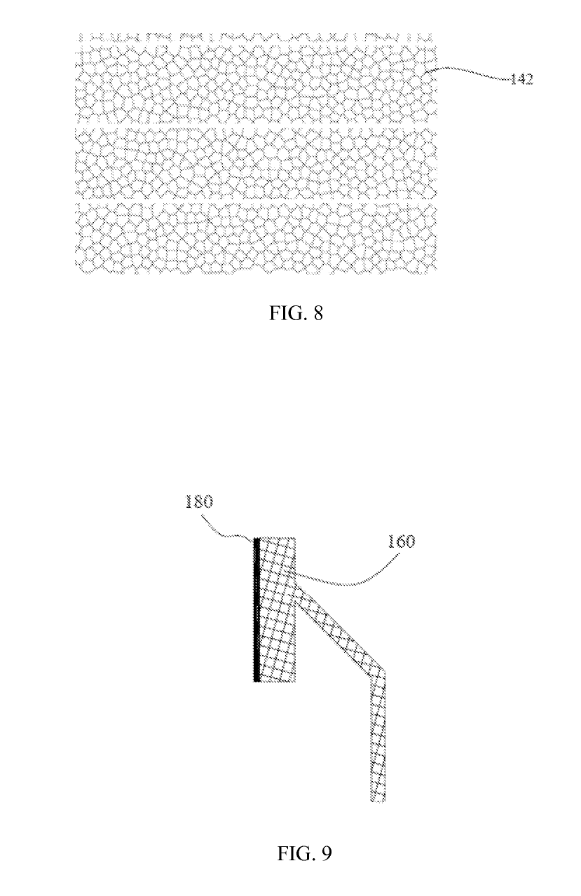

In this embodiment, each of the second conductive strips 142 is a conductive grid formed by multiple intersected fine conductive wires, where the width of the fine conductive wires are in a range of 200 nm-5 μm and the thickness of the fine conductive wires is smaller than the thickness of the insulating adhesive layer 130. The intersection of two adjacent fine conductive wires constitutes a node of the conductive grid and the distance between each two adjacent nodes is in a range of 50 μm˜500 μm. The conductive grid is received in grid-shaped grooves, and formed by a cured conductive material. As shown in FIG. 6, FIG. 7 and FIG. 8, the shape of a grid unit may be regular hexagon, diamond, rectangle or other irregular shape. As the grids can be made visually transparent through controlling the width and density of the grid lines, the second conductive strips 142 can be made of a wide range of materials, which may be conductive materials such as metal, graphene, carbon nanotube, indium tin oxide or conductive polymers and so on, where the metal may be at least one of gold, silver, copper, aluminum, molybdenum, nickel and zinc or alloy of various metals. When the conductive material with good conductivity is used, the resistances of the second conductive strips 142 can be greatly reduced, thereby reducing the energy consumption of the touch screen sensing module.

The second electrode leads 160 are embedded in the insulating adhesive layer 130. There are multiple second electrode leads 160. Each of the second electrode leads 160 is electrically connected with one of the multiple second conductive strips 142 respectively, in particular, electrically connected with at least two fine conductive wires of each conductive grid, so as to enhance the electrical connectivity between the second electrode leads 160 and the second conductive strips 140. In this embodiment, the multiple second electrode leads 160 are divided into two groups, which are respectively arranged at the two sides of the second conductive layer 140 around the recess 132 and eventually converge to the circuit board 170 located at the recess 132. In other embodiments, when the second conductive strips 142 are solid strips, the second electrode leads 160 may be electrically connected to the second conductive strips 142 directly.

In this embodiment, the second electrode leads 160 are conductive grids formed by intersected fine conductive wires. The fine conductive wires of the second electrode leads 160 have a width of 200 nm-5 μm and a thickness smaller than the thickness of the insulating adhesive layer 130. The intersection of each two adjacent fine conductive wires forms a node of the conductive grid. The distance between any two adjacent nodes is 10 μm˜100 μm. As shown in FIG. 9, the grid-shaped second electrode lead 160 is electrically connected with the grid-shaped second conductive grid 142 through an electrode connecting wire 180, where the electrode connecting wire 180 is electrically connected with at least two fine conductive wires of the second conductive strip 142 and at least two fine conductive wires of the second electrode lead 160. The second electrode lead 160 may be formed through etching a metal coating or screen printing conductive silver paste. The second electrode lead 160 has a grid structure, which facilitates scratching when filling a conductive material and the conductive material is more likely to be retained instead of being scratched away. Meanwhile, for the nanoscale conductive silver paste, scattering silver balls due to agglomeration effect will not be produced during sintering and therefore fracture of the second electrode leads due to silver balls can be avoided.

It should be understood that in other embodiments, the second electrode leads 160 may be solid wires, and accordingly, the second electrode leads 160 may be electrically connected to at least two fine conductive wires of the grid-shaped second conductive strips 142 directly.

In other embodiments, when the insulating adhesive layer 130 is formed by multiple laminated adhesive layers, the second conductive strips 142 and the second electrode leads 160 may be embedded in the top adhesive layer, such as embedded in the second adhesive layer.

A touch screen sensing module 100 with above structures has only one layer of substrate 110, compared to the conventional structure of two layers of glass substrates, the thickness is significantly reduced, the material is saved, the cost is relatively low. Thereby, the display device 10 adopting the touch screen sensing module 100 also has a relatively low thickness and cost, which is conducive to the realization of ultra-thin product.

In other embodiments, it is possible that the touch screen sensing module 100 does not include some components such as the first electrode leads 150, the second electrode leads 160 and the circuit board 170 and so on, these components can be assembled subsequently during assembling the display device 10.

Further, this embodiment also provides a method for manufacturing a touch screen sensing module, and the method includes:

Step one: applying a layer of conductive film on a surface of a substrate by vacuum sputtering or evaporation, coating photoresist on the conductive layer and forming multiple parallel first conductive strips from the conductive layer through exposure, development and etching process, where the multiple first conductive strips form a first conductive layer.

Specifically, in this embodiment, the substrate has a rectangular shape, an extending direction of the first conductive strips is parallel to the length direction of the substrate, and there is a gap between the adjacent first conductive strips and the adjacent first conductive strips are insulated.

In addition, in this embodiment, after the first conductive layer is formed, first electrode leads which are electrically connected with the first conductive strips are formed at an end of the first conductive strips, in particular the step includes:

at an end of the first conductive layer, plating a metal layer, coating photoresist on the metal layer, and forming the multiple first electrode leads through exposure, development and etching process, where the multiple first electrode leads are electrically connected to the multiple first conductive strips respectively; or

printing multiple conductive silver paste strips at an end of the first conductive layer by screen printing to form the first electrode leads, where the multiple conductive silver paste strips are electrically connected to the multiple first conductive strips respectively.

Step two: coating the substrate with an insulating adhesive layer, where the insulating adhesive layer covers the first conductive layer.

The insulating adhesive layer may be coated through blade coating or spin coating etc.

In other embodiments, the step of coating the insulating adhesive layer may include coating the substrate with a first adhesive layer covering the first conductive layer, coating a surface of the first adhesive layer with a second adhesive layer for being embossed after the first layer is cured. That is, the insulating adhesive layer may be formed by one adhesive layer or by multiple adhesive layers.

On one hand the insulating adhesive layer can play the role of insulation, on the other hand it can prevent the first conductive layer from being damaged in the subsequent production of the second conductive layer.

The insulating adhesive layer has a recess at a side of the first conductive layer to facilitate electrical connection between the subsequently-mounted circuit board with the first electrode leads and second electrode leads.

Step three: embossing on the insulating adhesive layer by using embossing mold to form multiple strip-shaped grooves overlapping with the first conductive strips, where the strip-shaped grooves include multiple grid groove units connected to each other, and the strip-shaped grooves are insulatedly spaced apart from the first conductive strips in the thickness direction of the substrate.

In this embodiment, the produced strip-shaped grooves are perpendicular to the first conductive strips. When the insulation adhesive layer is formed by multiple adhesive layers, the strip-shaped grooves are formed on the top adhesive layer, for example the second adhesive layer described above.

The embossing surface of the embossing mold is provided with multiple parallel grid-shaped embossments, where the width of the grid line is 200 nm-5 μm, and thus the bottoms of the produced grid-shaped grooves also appear a grip shape. In other embodiments, the embossing surface of the embossing mold may have embossment with smooth surface.

Step Four: filling a conductive material in the strip-shaped grooves to form second conductive strips after being cured so as to obtain a touch screen sensing module, where the multiple second conductive strips form a second conductive layer.

In this embodiment, the method further includes the step for forming multiple second electrode lead grooves which are connected with the multiple strip-shaped grooves respectively through embossing when embossing to form the strip-shaped grooves, and then filling a conductive material in the second electrode lead grooves to form the second electrode leads electrically connected to the second conductive strips. Where the embossing surface of the embossing mold is provided with multiple parallel grid-shaped embossments for forming the second conductive strips through embossing and multiple grid-shaped embossments or solid embossments, each of which is connected to one of the multiple parallel grid-shaped embossments, for forming the second electrode lead grooves through embossing.

The second electrode lead can also be formed using the following steps:

plating at both ends of the second conductive layer a metal layer, coating photoresist on the metal layer, and forming the multiple second electrode leads, which are electrically connected to the multiple second conductive strips respectively, through exposure, development and etching process; or

printing multiple conductive silver paste strips at the both ends of the second conductive layer by screen printing to form the second electrode leads, where the multiple conductive silver paste strips are electrically connected to the multiple second conductive strips respectively.

The above manufacturing method of touch screen sensing module is implemented through coating—photoetching—etching—embossing process, so the production process is relatively simple; the second conductive layer is produced through embossing to avoid waste of conductive material due to the etching process, and thus the cost is reduced. The obtained first conductive layer and second conductive layer can be aligned according to a preset manner, and therefore the yield of the obtained products is increased.

The above embodiments merely describe several implementing modes of the invention with specific details, but should not be understood as limiting the scope of the invention. It shall be noted that: persons skilled in the prior art, without departing from the concept of the invention, also may make modifications and improvements, which all belong to the protection scope of the invention. Therefore, the protection scope of the invention shall be defined by the appended claims.

What is claimed is:

1. A touch screen sensing module, comprising a substrate, a first conductive layer and a second conductive layer laminated over each other; wherein an insulating adhesive layer is provided between the first conductive layer and the second conductive layer to insulate the first conductive layer from the second conductive layer; the first conductive layer comprises multiple parallel first conductive strips on the substrate, and material of the first conductive strips is transparent semiconductor oxide; the second conductive layer comprises multiple parallel second conductive strips embedded in the insulating adhesive layer, each of the second conductive strips is a conductive grid formed by intersected fine conductive wires; grid-shaped grooves are defined on a surface of the insulating adhesive layer and the second conductive strips are formed by curing a conductive material received in the grid-shaped grooves; the first conductive strips and the second conductive strips are insulatedly spaced apart and overlapped with each other in a thickness direction of the substrate.

2. The touch screen sensing module according to claim 1, wherein the insulating adhesive layer comprises a first adhesive layer provided on the substrate and a second adhesive layer provided on the first adhesive layer, wherein the first adhesive layer covers the first conductive layer and the second conductive strips are embedded in the second adhesive layer.

3. The touch screen sensing module according to claim 1, further comprising first electrode leads electrically connected to the first conductive strips and second electrode leads electrically connected to the second conductive strips.

4. The touch screen sensing module according to claim 3, wherein a recess is provided on a side edge of the insulating adhesive layer, the recess directly faces free ends of the first electrode leads and free ends of the second electrode leads are located at a side of the recess.

5. The touch screen sensing module according to claim 4, wherein the second electrode leads are divided into two groups and the free ends of the two groups of the second electrode leads are respectively located at two sides of the recess.

6. The touch screen sensing module according to claim 3, wherein the second electrode leads are solid metal wires and each of the second electrode leads is electrically connected to at least two fine conductive wires of one of the second conductive strips.

7. The touch screen sensing module according to claim 3, wherein each of the second electrode leads is a conductive grid formed by intersected fine conductive wires, a grid density of the second electrode leads is less than a grid density of the second conductive strips, the second electrode leads are electrically connected to the second conductive strips through solid electrode connecting wires, each of the electrode connecting wires is electrically connected with at least two fine conductive wires of one of the grid-shaped second conductive strips and at least two fine conductive wires of one of the grid-shaped second electrode leads.

8. A display device, comprising a touch screen sensing module which comprises a substrate, a first conductive layer and a second conductive layer laminated over each other;
wherein an insulating adhesive layer is provided between the first conductive layer and the second conductive layer to insulate the first conductive layer from the second conductive layer; the first conductive layer comprises multiple parallel first conductive strips on the substrate, and material of the first conductive strips is transparent semiconductor oxide; the second conductive layer comprises multiple parallel second conductive strips embedded in the insulating adhesive layer, each of the second conductive strips is a conductive grid formed by intersected fine conductive wires; grid-shaped grooves are defined on a surface of the insulating adhesive layer and the second conductive strips are formed by curing a conductive material received in the grid-shaped grooves; the first conductive strips and the second conductive strips are insulatedly spaced apart and overlapped with each other in a thickness direction of the substrate.

9. The display device according to claim 8, wherein the insulating adhesive layer comprises a first adhesive layer provided on the substrate and a second adhesive layer provided on the first adhesive layer, wherein the first adhesive layer covers the first conductive layer and the second conductive strips are embedded in the second adhesive layer.

10. The display device according to claim 8, wherein the touch screen sensing module further comprises first electrode leads electrically connected to the first conductive strips and second electrode leads electrically connected to the second conductive strips.

11. The display device according to claim 10, wherein a recess is provided on a side edge of the insulating adhesive layer, the recess directly faces free ends of the first electrode leads and free ends of the second electrode leads are located at a side of the recess.

12. The display device according to claim 10, wherein the second electrode leads are solid metal wires and each of the second electrode leads is electrically connected to at least two fine conductive wires of one of the second conductive strips.

13. The display device according to claim 10, wherein each of the second electrode leads is a conductive grid formed by intersected fine conductive wires, a grid density of the second electrode leads is less than a grid density of the second conductive strips, the second electrode leads are electrically connected to the second conductive strips through solid electrode connecting wires, each of the electrode connecting wires is electrically connected with at least two fine conductive wires of one of the grid-shaped second conductive strips and at least two fine conductive wires of one of the grid-shaped second electrode leads.

14. A manufacturing method of touch screen sensing module, comprising following steps:
applying a layer of conductive film on a surface of a substrate by vacuum sputtering or evaporation, coating photoresist on the conductive layer, forming multiple parallel first conductive strips from the conductive layer through exposure, development and etching process, wherein the multiple first conductive strips form a first conductive layer;
coating the substrate with an insulating adhesive layer, wherein the insulating adhesive layer covers the first conductive layer;
embossing on the insulating adhesive layer by using embossing mold to form multiple strip-shaped grooves overlapping with the first conductive strips, wherein the strip-shaped grooves comprise multiple interconnected grid groove units and the strip-shaped grooves are insulatedly spaced apart from the first conductive strips in a thickness direction of the substrate;
filling a conductive material in the strip-shaped grooves to form second conductive strips after being cured so as to obtain a touch screen sensing module, wherein the multiple second conductive strips form a second conductive layer.

15. The manufacturing method of touch screen sensing module according to claim 14, wherein an embossing surface of the embossing mold is provided with multiple parallel grid-shaped embossments.

16. The manufacturing method of touch screen sensing module according to claim 14, further comprising a step after forming the first conductive layer for forming first electrode leads which are electrically connected with the first conductive strips at an end of the first conductive strips, wherein the step comprises:
plating a metal layer at the end of the first conductive layer, coating photoresist on the metal layer, and forming the multiple first electrode leads through exposure, development and etching process, wherein the multiple first electrode leads are electrically connected to the multiple first conductive strips respectively; or
printing multiple conductive silver paste strips at the end of the first conductive layer by screen printing to form the first electrode leads, wherein the multiple conductive silver paste strips are electrically connected to the multiple first conductive strips respectively.

17. The manufacturing method of touch screen sensing module according to claim 14, wherein the coating an insulating adhesive layer comprises coating the substrate with a first adhesive layer covering the first conductive layer, and coating, after the first layer is cured, a surface of the first adhesive layer with a second adhesive layer for embossing, wherein the strip-shaped grooves are formed on the second layer.

18. The manufacturing method of touch screen sensing module according to claim 14, further comprising a step for forming multiple second electrode lead grooves which are connected with the multiple strip-shaped grooves respectively through embossing when forming the strip-shaped grooves through embossing, and then filling a conductive material in the second electrode lead grooves to form second electrode leads electrically connected to the second conductive strips.

19. The manufacturing method of touch screen sensing module according to claim 18, wherein an embossing surface of an embossing mold is provided with multiple parallel grid-shaped embossments for forming the second conductive strips through embossing and provided with multiple grid-shaped embossments or solid embossments respectively connected to the multiple parallel grid-shaped embossments for forming the second electrode leads through embossing.

20. The manufacturing method of touch screen sensing module according to claim 14, further comprising a step for forming the second electrode leads which are electrically connected to the second conductive strips at a side of the second conductive layer after forming the second conductive layer, wherein the step comprises:
plating at both ends of the second conductive layer a metal layer, coating photoresist on the metal layer, and forming the multiple second electrode leads through exposure, development and etching process, which are electrically connected to the multiple second conductive strips respectively; or
printing multiple conductive silver paste strips at the both ends of the second conductive layer by screen printing to form the second electrode leads, wherein the multiple conductive silver paste strips are electrically connected to the multiple second conductive strips respectively.
